(19) United States
(12) Patent Application Publication
(10) Pub. No.: US 2011/0193340 A1
(43) Pub. Date: Aug. 11, 2011

(54) FLEXIBLE JOINT FOR LARGE-DIAMETER RISER PIPES

(75) Inventor: Peter Alan Lunde, Cypress, TX (US)

(73) Assignee: Seahorse Equipment Corp., Houston, TX (US)

(21) Appl. No.: 13/023,223

(22) Filed: Feb. 8, 2011

Related U.S. Application Data
(60) Provisional application No. 61/302,386, filed on Feb. 8, 2010.

(51) Int. Cl. F16L 27/10

(52) U.S. Cl. 285/223; 285/148.3

(57) ABSTRACT

A flexible pipe joint achieves flexibility between pipe sections using a plurality of elastomeric pads arranged to create a spherical acting joint. The angle of the pads (and resulting radius of the sphere) can be selected to optimize the internal loads and relative motions of the mating parts. The use of the flex joints reduces bending moments in the pipe from vessel motions and current loads. Stability of the assembly may be maintained by having sufficient weight on the lower sections of the riser to resist current loads. A soft elastomeric seal minimizes fluid loss and allows relative motions of the pipe at the joint. The connector may be mated by inserting the inner pipe into the outer pipe and then rotating the pipe sections relative to each other until a stop is reached. A separate latch may be set, or automatically set, to prevent reverse rotation and unlatching.

### CROSS-REFERENCE TO RELATED APPLICATIONS

This application claims the benefit of U.S. Provisional Application No. 61/302,386 filed Feb. 8, 2010.

### STATEMENT REGARDING FEDERALLY SPONSORED RESEARCH OR DEVELOPMENT

Not Applicable

### BACKGROUND OF THE INVENTION

1. Field of the Invention

This invention relates to pipe joints. More particularly, it relates to flexible pipe joints for subsea riser pipes having a large diameter.

2. Description of the Related Art Including Information Disclosed Under 37 CFR 1.97 and 1.98.

Ocean thermal energy conversion (OTEC) makes use of the temperature difference that exists between deep and shallow waters to power a heat engine. As with any heat engine, the greatest efficiency and power are produced with the largest temperature difference. This temperature difference generally increases with decreasing latitude, i.e. near the equator, in the tropics. Historically, the main technical challenge of OTEC has been to generate significant amounts of power, efficiently, from this very small temperature differential. Changes in efficiency of heat exchange in modern designs allow performance approaching the theoretical maximum efficiency.

The Earth's oceans are heated by the sun and cover nearly 70% of the Earth's surface. This temperature difference holds a vast amount of solar energy which can potentially be harnessed for human use. If this extraction could be made cost effective on a large scale, it could provide a source of renewable energy needed to deal with energy shortages, and other energy problems. The total energy available is generally considered to be one or two orders of magnitude greater than other ocean energy options such as wave power, but the small magnitude of the temperature difference makes energy extraction comparatively difficult and expensive due to low thermal efficiency. Earlier OTEC systems had an overall efficiency of only 1 to 3% (the theoretical maximum efficiency probably lies between 6 and 7%) Current designs being considered will likely be able to operate closer to the theoretical maximum efficiency. The energy carrier, seawater, is free, although it has an access cost associated with the pumping materials and pump energy costs. Even though an OTEC plant operates at a low overall efficiency, it can be configured to operate continuously as a base load power generation system. Any thorough cost-benefit analysis should include these factors to provide an accurate assessment of performance, efficiency, operational and construction costs and returns on investment.

The concept of a heat engine is very common in thermodynamics engineering, and much of the energy used by humans passes through a heat engine. A heat engine is a thermodynamic device placed between a high temperature reservoir and a low temperature reservoir. As heat flows from one to the other, the engine converts some of the heat energy to work energy. This principle is used in steam turbines and internal combustion engines, while refrigerators reverse the direction of flow of both the heat and work energy. Rather than using heat energy from the burning of fuel, OTEC power draws on temperature differences caused by the sun's warming of the ocean surface.

At present, the only heat cycle generally considered suitable for OTEC, is the Rankine cycle, using a low-pressure turbine. Systems may be either closed-cycle or open-cycle. Closed-cycle engines use working fluids that are typically thought of as refrigerants such as ammonia or R-134a. Open-cycle engines use the water heat source as the working fluid.

Some energy experts believe that if it could become cost-competitive with conventional power technologies, OTEC could produce multiple gigawatts of electrical power, and, when used in conjunction with electrolysis, could produce enough hydrogen to completely replace all projected global fossil fuel consumption. Managing costs is still a huge challenge, however. All OTEC plants require an expensive, large diameter intake pipe, which is submerged a kilometer or more into the ocean's depths, in order to bring relatively cold water to the surface. Constructing and supporting such a large pipe (riser) presents many engineering challenges. One such challenge is providing a flexible joint between pipe segments to enable the pipe to flex in response to ocean currents and wave action on the supporting vessel. Without the ability to flex, the riser pipe may develop cracks and fail. The flexible pipe joints currently known and in use for subsea risers are not suitable for very large diameter pipes. The present invention solves this problem.

### BRIEF SUMMARY OF THE INVENTION

Flexibility between pipe sections is achieved by means of an elastomeric flex joint based on using several elastomeric pads arranged to create a spherical acting joint. The angle of the pads (and resulting radius of the sphere) can be selected to optimize the internal loads and relative motions of the mating parts. A spherical elastomeric bearing according to the invention is similar in concept to that used to support large mooring turrets. The use of the flex joints reduces bending moments in the pipe from vessel motions and current loads. Stability of the riser pipe assembly may be maintained by having sufficient weight on the lower sections of the riser to resist current loads. A soft elastomeric seal minimizes fluid loss and allows relative motions of the pipe at the joint.

The connector may be mated by inserting the inner pipe into the outer pipe and then rotating the pipe sections relative to each other until a stop is reached. This is like a breach block connector. A separate latch may be set, or may be automatically be set, to prevent reverse rotation and unlatching.

The riser pipe can be assembled by adding sections to the top or to the bottom of the riser.

### BRIEF DESCRIPTION OF THE SEVERAL VIEWS OF THE DRAWING(S)

FIG. 1 is a longitudinal cross-section of one embodiment of the invention.

FIG. 2 is a transverse cross-section of the flexible joint illustrated in FIG. 1.

FIG. 3 is a longitudinal cross-section of the flexible joint illustrated in FIG. 1 shown with the lower pipe section displaced from the vertical.

### DETAILED DESCRIPTION OF THE INVENTION

The invention may best be understood by reference to certain illustrative embodiments which are shown in the drawing figures.

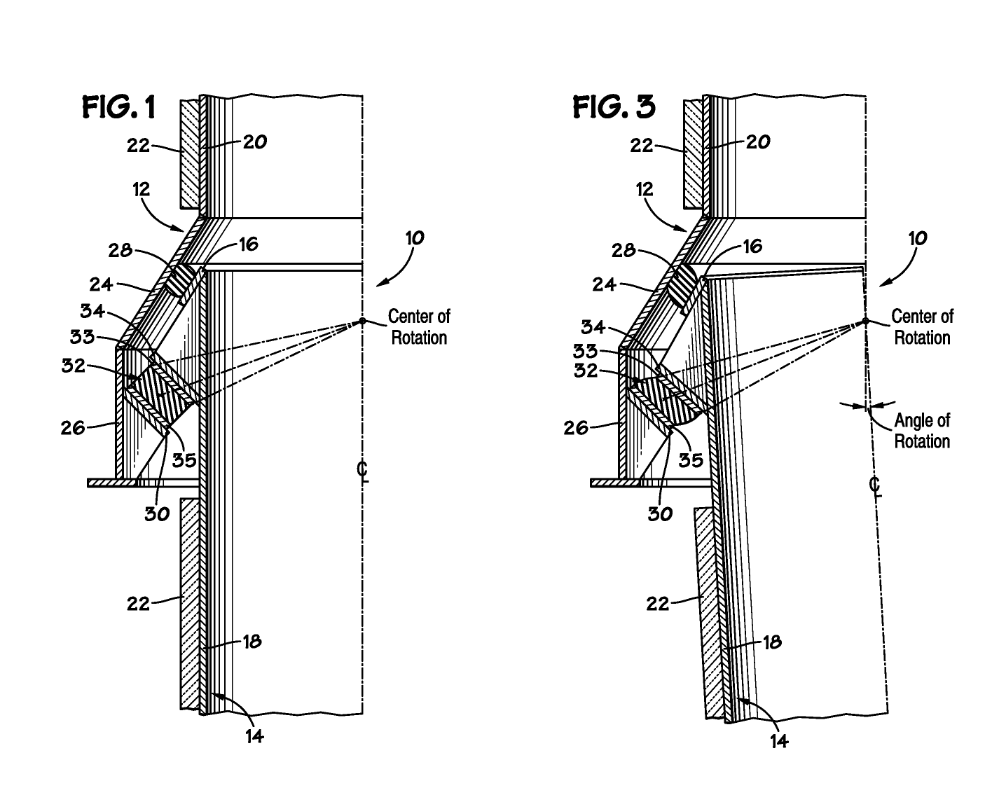

Referring to FIG. 1, a flexible joint (“flexjoint”) 10 comprised of outer pipe connector 12 and inner pipe connector 14 is shown in longitudinal cross section. Outer pipe connector 12 includes outer pipe wall 20 and larger-diameter receiving section 26 which are connected by angled transition section 24.

The upper (in FIG. 1) end of inner pipe wall 18 may terminate at angled seal surface 16. The juncture between seal surface 16 and the inner surface of transition section 24 may be sealed by soft elastomeric seal 28.

The pipe sections may have optional insulation 22 to minimize heat loss to the surrounding water.

Pad support structure 30 is attached to wall segment 26 and elastomeric pad assembly 32 is attached to pad support 30. In the illustrated embodiment, pad assembly 32 comprises an elastomer sandwiched between first metal plate 33 and opposing second metal plate 35. Metal plates 33 and 35 may be steel plates. The elastomer may be bonded to steel plate 33 and/or steel plate 35. Pad contactor 34 is attached to inner pipe wall 18 in generally parallel relation to pad support structure 30. In the illustrated embodiment, there is no connection between the top plate of pad 32 and pad contactor 34. In yet other embodiments, elastomeric pad assembly 32 is connected to pad contactor 34 and no connection exists between the pad bottom plate and pad support 30.

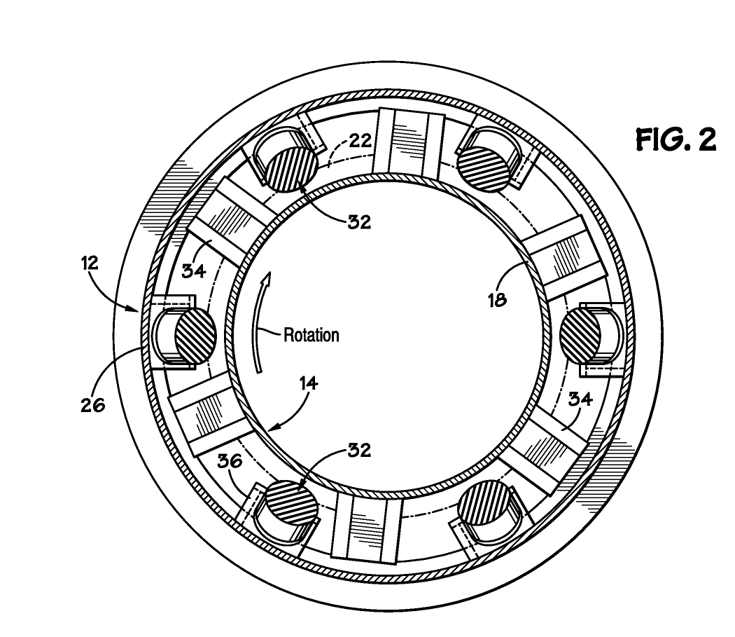

Referring now to FIG. 2, two pipe sections in the process of being joined are shown. Inner pipe connector 14 is inserted into outer pipe connector 12 such that pad contactors 34 are angularly displaced from elastomeric pad assemblies 32. The inner pipe is inserted into the outer pipe (female) connector sufficiently to ensure that lower surfaces of pad contactors 34 are above elastomeric pad assemblies 32. Inner pipe 14 may then be rotated to align pad contactors 34 with pad assemblies 32. Rotation stop 36 may be provided to ensure that this rotation stops at the proper point. When alignment is achieved, inner pipe 14 may be lowered and pad contractors 34 will bear against elastomer pads 32 under the weight of pipe 14.

Referring to FIG. 3, the pipe joint is shown responding to a deflection of lower pipe 18 to the right (in the drawing figure). Such a deflection might be produced, for example, by a current flowing left to right in the drawing figure.

It can be seen in FIG. 3 that a deflection of lower pipe 18 from the vertical will load elastomer pad 32 in sheer. For this reason, in certain preferred embodiments, elastomeric pad 32 is fabricated from a material that is relatively stiff in the axial direction and relatively soft in shear. Pad assemblies that achieve high axial stiffness (compression) may be constructed by layering one or more elastomers with steel plates. Such layering has minimal effect on the shear stiffness of the pad and it can remain relatively low.

Although the invention has been described in detail with reference to certain preferred embodiments, variations and modifications exist within the scope and spirit of the invention as described and defined in the following claims.

What is claimed is:

1. A flexible joint for a riser pipe comprising:
an outer pipe connector having a plurality of pad support structures positioned around its inner circumference.
at least one elastomeric pad connected to each pad support structure;
an inner pipe connector having a diameter less than that of the outer pipe connector and having a plurality of pad contactors attached to its outer circumference in spaced apart relation.

2. A flexible joint for a riser pipe as recited in claim 1 further comprising an annular surface proximate one end of the inner pipe connector disposed at an acute angle to the longitudinal axis of the inner pipe connector.

3. A flexible joint for a riser pipe as recited in claim 2 further comprising a seal between the angled, annular surface on the inner pipe connector and an inner surface of the outer pipe connector.

4. A flexible joint for a riser pipe as recited in claim 3 wherein the seal is a soft seal.

5. A flexible joint for a riser pipe as recited in claim 3 wherein the seal is an elastomeric seal.

6. A flexible joint for a riser pipe as recited in claim 2 further comprising a section of the outer pipe connector disposed at an angle to the longitudinal axis of the outer pipe connector.

7. A flexible joint for a riser pipe as recited in claim 2 further comprising a section of the outer pipe connector disposed at an angle to the longitudinal axis of the outer pipe connector such that it is substantially parallel to the angled, annular surface on the inner pip connector

8. A flexible joint for a riser pipe as recited in claim 1 further comprising means for limiting the rotation of the inner pipe connector relative to the outer pipe connector.

9. A flexible joint for a riser pipe as recited in claim 1 further comprising means for stopping the rotation of the inner pipe connector relative to the outer pipe connector when the pad contactors attached to the outer circumference of the inner pipe connector are aligned with the pad support structures positioned around the inner circumference of the outer pipe connector.

10. A flexible joint for a riser pipe as recited in claim 1 further comprising automatic means for holding the angular displacement of the inner pipe connector relative to the outer pipe connector when the pad contactors attached to the outer circumference of the inner pipe connector align with the pad support structures positioned around the inner circumference of the outer pipe connector.

11. A riser pipe comprising:
an upper segment with an outer pipe connector at a lower end thereof having a plurality of pad support structures positioned around its inner circumference.
at least one elastomeric pad connected to each pad support structure;
a lower segment with an inner pipe connector at an upper end thereof having a diameter less than that of the outer pipe connector and having a plurality of pad contactors attached to its outer circumference in spaced apart relation.

12. A riser pipe as recited in claim 11 further comprising an annular surface proximate one end of the inner pipe connector disposed at an acute angle to the longitudinal axis of the inner pipe connector.

13. A riser pipe as recited in claim 12 further comprising a seal between the angled, annular surface on the inner pipe connector and an inner surface of the outer pipe connector.

14. A riser pipe as recited in claim 13 wherein the seal is a soft seal.

15. A riser pipe as recited in claim 13 wherein the seal is an elastomeric seal.

16. A riser pipe as recited in claim 12 further comprising a section of the outer pipe connector disposed at an angle to the longitudinal axis of the outer pipe connector.

17. A riser pipe as recited in claim 12 further comprising a section of the outer pipe connector disposed at an angle to the longitudinal axis of the outer pipe connector such that it is substantially parallel to the angled, annular surface on the inner pip connector

18. A riser pipe as recited in claim 11 further comprising means for limiting the rotation of the inner pipe connector relative to the outer pipe connector.

19. A riser pipe as recited in claim 11 further comprising means for stopping the rotation of the inner pipe connector relative to the outer pipe connector when the pad contactors attached to the outer circumference of the inner pipe connector are aligned with the pad support structures positioned around the inner circumference of the outer pipe connector.

20. A riser pipe as recited in claim 11 further comprising automatic means for holding the angular displacement of the inner pipe connector relative to the outer pipe connector when the pad contactors attached to the outer circumference of the inner pipe connector align with the pad support structures positioned around the inner circumference of the outer pipe connector.
